(19) United States
(12) Patent Application Publication
(10) Pub. No.: US 2015/0356692 A1
(43) Pub. Date: Dec. 10, 2015

(54) TUNING CROWDSOURCED HUMAN INTELLIGENCE TASK OPTIONS THROUGH FLIGHTING

(71) Applicant: Microsoft Corporation, Redmond, WA (US)

(72) Inventors: Steven Shelford, Vancouver (CA); Rajesh Patel, Woodinville, WA (US); Yunling Wang, Redmond, WA (US)

(21) Appl. No.: 14/301,320

(22) Filed: Jun. 10, 2014

(51) Int. Cl. G06Q 50/00; G06Q 10/06; H04L 29/08

(52) U.S. Cl. CPC G06Q 50/01; H04L 67/10; G06Q 10/06311

(57) ABSTRACT

Different options associated with the performance of intelligence tasks are flighted. Different versions of applications that provide the context within which intelligence tasks are performed are sourced for each of the different combinations of options. Subsets of the human workers are selected and provided such different versions of such applications. Correlations are made between those applications that were selected by individual workers and the options that such applications represented, and further between intelligence task results, including, optionally, an evaluation of the quality of such task results, and such options. Options, and the settings thereof, which affect and optimize the intelligence task results generated by workers, are, thereby, more efficiently identified.

### BACKGROUND

As an increasing number of people gain access to networked computing devices, the ability to distribute intelligence tasks to multiple individuals increases. Moreover, a greater quantity of people can be available to perform intelligence tasks, enabling the performance of such tasks in parallel to be more efficient, and increasing the possibility that individuals having particularized knowledge or skill sets can be brought to bear on such intelligence tasks. Consequently, the popularity of utilizing large groups of disparate individuals to perform intelligence tasks continues to increase.

The term “crowdsourcing” is often utilized to refer to the distribution of discrete tasks to multiple individuals, to be performed in parallel, especially within the context where the individuals performing the task are not specifically selected from a larger pool of candidates, but rather those individuals individually choose to provide their effort in exchange for compensation. Existing computing-based crowdsourcing platforms distribute intelligence tasks to human workers, typically through network communications between the computing devices implementing such crowdsourcing platforms, and each human worker's individual computing device. More specifically, crowdsourcing platforms typically provide individual human workers with multiple different intelligence tasks, or types of intelligence tasks, thereby enabling the individual human workers to choose the intelligence tasks that they will perform. Crowdsourcing platforms typically receive such intelligence tasks from task owners that desire to utilize crowdsourcing to perform such tasks. Task owners, therefore, provide intelligence tasks, and individual human workers choose to perform such intelligence tasks and return the results to the task owners. Such an exchange is coordinated by computing-based outsourcing platforms.

### SUMMARY

A crowdsourcing service can provide task owners with the ability to flight different options associated with the performance of those task owners' intelligence tasks. Different versions of applications that provide the context within which intelligence tasks are performed can be sourced for each of the different combinations of options. Subsets of the human workers can be selected by the crowdsourcing service to receive such different versions of such applications. Such a selection can be random, or it can specifically target individual human workers, or specific types of human workers. Upon provision of the different versions of the applications to the human users, the crowdsourcing service can determine which are selected by the human users, and can receive the results of the intelligence tasks performed by such human users through such applications. The crowdsourcing service can further provide evaluations to task owners, correlating those applications that were selected by individual workers to the options that such applications represented, and further correlating intelligence task results, including, optionally, an evaluation of the quality of such task results, to the options represented by the applications through which such intelligence task results were generated. In such a manner, a task owner can more efficiently determine which options, and corresponding option settings, affect the quality and other metrics of the intelligence task results that are generated by human workers, such as those to whom such options and settings were flighted. The task owner can then more efficiently select and set option settings that improve the quality of the intelligence task results that are generated by human workers within the context defined by such options settings.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary system through which intelligence task applications can be flighted.

FIG. 2 is a block diagram of an exemplary set of components for flighting intelligence task applications.

FIG. 3 is a flow diagram of an exemplary flighting intelligence task applications; and

FIG. 4 is a block diagram of an exemplary computing device.

### DETAILED DESCRIPTION

The following description relates to the evaluation of different options associated with human intelligence tasks that are presented to human workers for performance by such human workers. The human intelligence tasks are performed by human workers within contexts generated by applications conveying such options. Different versions of those applications, representing different combinations of options, are provided to subsets of the human workers. Such subsets can be randomly selected, or they can comprise specific, predefined human workers, or specific, predefined types of human workers. As the human workers select which intelligence tasks to perform and then subsequently perform those tasks, the results thereof can be utilized to correlate selection of an application with the options represented by such a version of the application, as well as to correlate the intelligence task results, including, optionally, correlating the quality of such results, to the options represented by the versions of the applications through which such human intelligence tasks were performed by the human workers. The task owner can, thereby, more efficiently determine which options, and corresponding option settings, affect the quality and other metrics of the intelligence task results that are generated by human workers, such as those to whom such options and settings were flighted. Based on such determinations, the task owner can more efficiently select and set option settings that improve the quality of the intelligence task results that are generated by human workers within the context that is defined by such options settings

The techniques described herein focus on crowdsourcing paradigms, where intelligence tasks are performed by human workers, from among a large pool of disparate and diverse human workers, who choose to perform such intelligence tasks. However, such descriptions are not meant to suggest a limitation of the described techniques. To the contrary, the described techniques are equally applicable to any human intelligence task processing paradigm, including paradigms where the human workers to whom HITs are assigned are specifically and individually selected or employed to perform such HITs. Consequently, references to crowdsourcing, and crowdsource-based human intelligence task processing paradigms are exemplary only and are not meant to limit the mechanisms described to only those environments.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

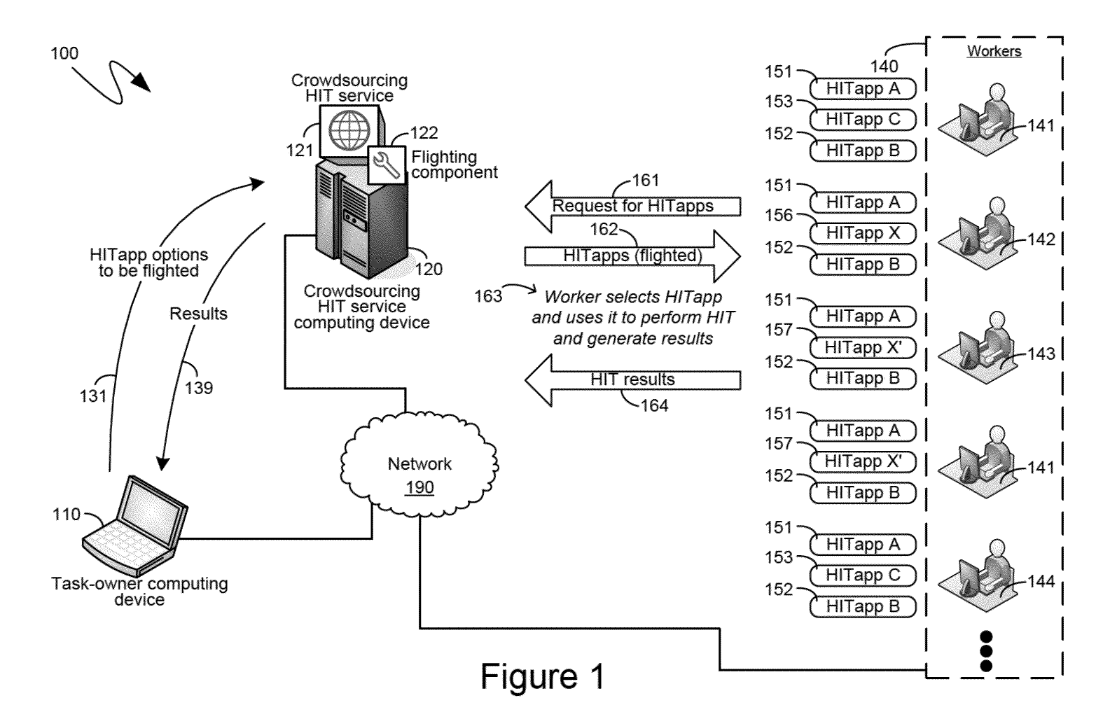

With reference to FIG. 1, an exemplary system 100 is illustrated, providing context for the descriptions below. As illustrated in FIG. 1, the exemplary system 100 can comprise human workers 140, including the illustrated human workers 141, 142, 143 and 144, a crowdsourcing service 121 that can be executed by one or more server computing devices, such as the exemplary server computing device 120, and a task owner computing device, such as the exemplary task owner computing device 110 by which a task owner can interface with the crowdsourcing service 121 and can utilize the crowdsourcing service 121 to obtain performance of human intelligence tasks by the human workers 140. The one or more server computing devices on which the crowdsourcing service 121 executes need not be dedicated server computing devices, and can, instead, be server computing devices executing multiple independent tasks, such as in a cloud-computing paradigm. Only a single exemplary server computing device 120 is illustrated to maintain graphical simplicity and legibility, but such an exemplary server computing device 120 is meant to represent one or more dedicated or cloud-computing server computing devices. The task owner computing device 110, the server computing devices on which the crowdsourcing service 121 executes, such as exemplary server computing device 120, and the computing devices of the human workers 140 can exchange computer-readable messages and can otherwise be communicationally coupled to one another through a network, such as the exemplary network 190 shown in FIG. 1.

According to one aspect, the crowdsourcing service 121 can comprise a flighting component 122 that can facilitate the exploration of different options and parameters associated with the performance of human intelligence tasks or “HITs”. More specifically, the workers 140 perform HITs through application generated interfaces, and the flighting component 122 can facilitate the exploration of different factors presented to workers to enable them to choose a particular application, as well as the exploration of options and parameters of performing the intelligence task through such applications. The applications that generate interfaces through which human intelligence tasks are performed, colloquially referred to as “HITapps”, can comprise computer-executable instructions that are downloaded to each individual worker's computing devices and execute thereon, computer-executable instructions that execute on server computing devices and provide their interfaces via communications across the network 190 to the individual workers utilizing their respective computing devices, scripts that are invoked by processes executing on each individual worker's computing devices, and combinations thereof.

When acting as a worker of the crowdsourcing service 121, each individual one of the workers 140 can, initially, be presented with the option to select among multiple HITapps, each of which can provide a worker with an opportunity to perform one or more HITs through an interface presented by, or a context generated by, such HITapps. To enable workers to meaningfully select among the multiple HITapps, information about such HITapps can be provided to the workers. Such HITapp metadata can include information regarding the price or fee that a worker will be paid upon completing one or more HITs through such a HITapp, information regarding the quantity of HITs available for the worker to perform, the description, categorization, or other like information descriptive of the HITs to be performed, and other like information.

Furthermore, the context generated by HITapps can, itself, comprise several adjustable options or parameters including, for example, the organization of the user interface presented by such a HITapp, the colors, textual styles, graphical sizing, and other like visual elements presented by a user interface of such a HITapp, the descriptive information provided within the HITapp-generated context, and other like parameters. When generating HITapps through which human workers will perform the HITs of a task, the task owner can be faced with a myriad of decisions regarding the establishment of the above described options. As one simple example, the task owner can be uncertain of an appropriate amount to pay each of the workers for the completion of one or more HITs. Should the task owner set such an amount too low, the human workers 140 may not desire to perform the HITs of the task, and the task can remain uncompleted. Or the human workers 140 may not be sufficiently motivated to generate high quality results for the HITs that they do perform. Conversely, should the task owner set such an amount too high, the task owner may be overpaying for the work performed by the human workers 140.

According to one aspect, therefore, a flighting component 122 can enable different HITapp options to be flighted, and can, thereby, provide a task owner with meaningful empirical data regarding the effect of such options on the workers 140. Utilizing such information, as will be detailed further below, the task owner can more efficiently identify optimal option settings by which the task owner can receive high quality results to the HITs performed by the workers 140 while minimizing the time and cost invested to receive such high quality HIT results. More specifically, the flighting component 122 can comprise mechanisms that can provide different versions of a HITapp, each having different option settings, to subsets of the workers 140, can monitor the behavior of the subsets of workers to which such different versions of a HITapp are provided, to correlate such empirical observations to the different option settings, and can, in such a manner, provide information to a task owner regarding the expected effect of various option settings that the task owner sought to explore through such flighting.

Initially, a task owner, such as through the task owner computing device 110 shown in the system 100 of FIG. 1, can communicate with the crowdsourcing service 121, and the flighting component 122, to identify one or more options for which the task owner desires to flight different option settings. In one aspect, such a communication can entail the task owner directly providing different versions of HITapps having such options already set. In another aspect, such a communication can entail the task owner merely identifying the options, and the different option settings, that they desire to have flighted. The exemplary communication 131, therefore, from the task on a computing device 110 to the crowdsourcing service 121 is meant to be illustrative of either aspect.

If the task owner only provides an the identification of the options, and different option settings, to be flighted, then the flighting component 122, or another aspect of the crowdsourcing service 121, can aid the task owner in generating different versions of HITapps representing such different option settings. For example, a default HITapp profile can be utilized to generate one HITapp version, from which other versions can be generated by varying option settings appropriately. Alternatively, as another example, the task owner may have generated one version of a HITapp, and the flighting component 122, or another aspect of the crowdsourcing service 121, can automatically generate other versions of that HITapp based upon the options identified by the task owner, and the different settings of those options that the task owner desires to flight.

As utilized herein, the term “HITapp versions” means the distinct applications that provide the context within which intelligence tasks are performed, where the difference between the distinct applications is that of the settings of one or more options, including the settings of one or more options defining application metadata, or other like information about the application. As one simple example, two different HITapp versions can present workers with two different fees that will be paid upon completion of one or more HITs through such HITapps. In such a simple example, the user interface presented by such different versions can be identical, and the only difference between the two HITapp versions can be, that when initially presented to a worker to choose between one of the two HITapp versions, and other HITapps that are also available to the worker, one worker, receiving one version of the HITapp, will be presented with information indicating that one fee will be paid, while another worker, receiving the other version of the same HITapp, will be presented with information indicating that a different fee will be paid.

Once such different versions of a HITapp, representing different combinations of options settings that a task owner desires to have flighted, are generated, the flighting component 122 can identify subsets of workers, such as of the workers 140, to which to flight such different versions of the HITapp. According to one aspect, the flighting component 122 can randomly select the subsets of the workers to whom to flight different versions of a HITapp. According to other aspects, however, the flighting component 122 can specifically select workers, or types of workers, to whom to flight different versions of a HITapp. For example, the flighting component 122 can choose to flight different versions of a HITapp only to workers that have been previously identified as being reliable or diligent workers. As another example, the flighting component 122 can choose to flight different versions of a HITapp only to workers that have previously completed at least a threshold quantity of HITs, such as through other HITapps.

According to one aspect, the subsets of workers to whom different versions of a HITapp will be flighted can be based on the quantity of different versions of the HITapp that are being flighted. For example, only a portion of workers can be selected to receive any versions of a HITapp that is being flighted. Such a selected portion can then be further divided, such as equally divided, based upon the quantity of different versions of the HITapp that are being flighted. As one specific example, a task owner can select, or the flighting component 122 can establish, that only twenty percent of the workers 140 will receive versions of the HITapp being flighted. In such a specific example, if there are two versions of the HITapp that are being flighted, then each version can be presented to ten percent of the workers 140. As indicated previously, such ten percent of the workers 140 can be randomly selected by the flighting component 122, or they can be selected based upon defined worker criteria.

As illustrated in the exemplary system 100 of FIG. 1, workers, such as exemplary workers 140, establish communications, such as via the network 190, with a crowdsourcing service, such as exemplary crowdsourcing service 121. As part of such communications, the workers 140 can, individually, request that the crowdsourcing service 121 provide them with one or more HITapps from which the workers 140 can, individually, choose a HITapp through which to perform HITs. For graphical simplicity and clarity of presentation each of the individual requests, such as from the exemplary individual workers 141, 142, 143 and 144, are generally illustrated by the communication 161 from the workers 140 to the crowdsourcing service 121. In response, the crowdsourcing service 121, including, optionally, in cooperation with the flighting component 122, can return one or more HITapps to each of the individual ones of the workers 140, thereby enabling those individual workers to individually select a HITapp through which to perform HITs, should they so desire. As before, for graphical simplicity and clarity of presentation, each of such individual presentations, by the crowdsourcing service 121, to each individual one's of the workers 140 are generally illustrated by the communication 162.

By way of an illustrative example, a specific one of the workers 140, namely the individual worker 141, can be presented with an interface, generated by the crowdsourcing service 121, that can provide the individual worker 141 with the choice of three HITapps, namely the HITapps 151, 152 and 153 shown in the system 100 of FIG. 1. The individual worker 141 can then choose from among those HITapps to perform HITs and be compensated therefore, or the individual worker 141 can choose to select none of those HITapps, and simply reconnect with the outsourcing service 121 at a later point in time. Another specific one of the workers 140, namely the individual worker 142, can, either simultaneously with the individual worker 141, or subsequently thereto, independently communicate with the crowdsourcing service 121, and receive therefrom an interface by which the individual worker 142 is also presented with a choice of three HITapps, which can include the same HITapps 151 and 152 that were presented to the individual worker 141. For purposes of illustration, however, in the present example, the individual worker 142 can be one of the workers selected, such as by the flighting component 122, to receive a version of a HITapp that is being flighted. In the present example such a flighted HITapp can be the HITapp 156 shown in FIG. 1 as being presented to the individual worker 142. As indicated previously, the selection of the individual worker 142 can have been based on specific attributes or aspects of the individual worker 142, or it can have been based on a random selection, such as, for example, if the individual worker 142 was simply the fifth worker to communicate with the crowdsourcing service 121 since the last individual worker to whom one of the flighted HITapps was provided. As in the case of the individual worker 141, the individual worker 142 can, upon being presented with the HITapps 151, 152 and 156, choose one of those HITapps through which to perform HITs, or choose to not perform HITs at the present time, and possibly reestablish communications with the crowdsourcing service 121 at a later time.

Continuing with the present, illustrative example, another individual worker, from among the workers 140, such as the exemplary individual worker 143, can, likewise, establish communications with the crowdsourcing service 121, and receive therefrom an interface through which the individual worker 143 can select from among one or more HITapps. As with the individual worker 142, the communications between the crowdsourcing service 121 and the individual worker 143 are independent of the communications between the crowdsourcing service 121 and any of the other individual ones of the workers 140. Consequently, in one example, the individual worker 143 can establish communications with the crowdsourcing service 121 after the above-described communications between the crowdsourcing service 121 and the individual worker 142. As part of the present, illustrative example, the individual worker 143 can, like the individual worker 142, be selected, such as by the flighting component 122, to receive one of the flighted HITapps. In the example illustrated by the system 100 of FIG. 1, the individual worker 143 can receive, in addition to the HITapps 151 and 152, which have been received by each of the aforementioned individual workers, a HITapp 157 that can be a different version of the HITapp 156 received by the individual worker 142. In other words, two different versions of a single HITapp are being flighted in the present, illustrated example, and those two versions are identified in the exemplary system of FIG. 1 as the HITapps 156 and 157, respectively. One version of such a HITapp that is being flighted, namely the HITapp 156, can have been provided to the individual worker 142, as described above. Similarly, the other version of such a HITapp that is being flighted, namely the HITapp 157, can have been provided to the individual worker 143. As with the individual worker 142, the individual worker 143 can select from among the HITapps 151, 152 and 157 presented to them, can select none of those and return to the crowdsourcing service at a later point in time.

In selecting individual ones of the workers 140 to whom to provide flighted HITapps, according to one aspect, the flighting component 122 can treat independent sessions with the same individual worker as different instances and opportunities to flight HITapps. For example, the above-described example, and as shown in the exemplary system 100 of FIG. 1, the individual worker 141 can have not received one of the two versions of the HITapp being flighted, namely the HITapp version 156 and the HITapp version 157. For purposes of illustration, continuing with the present example, the individual worker 141 can, at a subsequent time, reestablish communications with the crowdsourcing service 121. Such a reestablishment of communications is illustrated, in FIG. 1, by the individual worker 141 being shown both at the top of the collection of workers 140, shown on the right hand side of FIG. 1, and also, again, near the bottom of the collection of workers 140. In such a subsequent communicational session, for purposes of the present example, the individual worker 141 can be presented with one of the flighted versions, namely the flighted HITapp version 157, as well as the previously presented HITapps 151 and 152. As before, the individual worker 141 can choose to perform HITs through one of the presented HITapps 151, 152 or 157, or to not currently perform any HITs.

A subsequent individual worker 144 can, as described above, be presented with an interface through which the individual worker 144 can select to perform HITs through one or more HITapps proffered by such an interface. For purposes of continuing with the example, the individual worker 144 can be one of the workers 140 that is not part of the flights being coordinated by the flighting component 122. Consequently, in such an example, individual worker 144 can be presented with an interface that presents the same HITapps 151, 152 and 153 as the interface initially provided to the individual worker 141.

If any one of the workers selects one of the HITapps offered to them, such a worker can perform HITs via the context provided by the selected HITapp, and the results can be returned to the crowdsourcing service 121. The selection of a particular HITapp, and the subsequent generation of HIT results via such a HITapp is illustrated by the action 163 and the communication 164. Irrespective of the graphical illustration the communications 161, 162 and 164, and the graphical representation of the HITapps 151, 152, 153, 156 and 157, such illustrations and representations are not meant to limit the descriptions herein to situations where the HITapps are computer-executable instructions that execute locally on individual worker's client computing devices. Instead, as indicated previously, HITapps can comprise scripts or computer-executable instructions that execute at the crowdsourcing service 121, or otherwise remotely from the individual worker's client computing devices. In such instances, as will be recognized by those skilled in the art, the communications 161, 162 and 164 may not comprise explicit network communications, as such, since the relevant information may already be co-located with, for example, the crowdsourcing service 121.

The flighting component 122 can have access to the results 164 and can correlate worker behavior with various flighted options and their corresponding flighted settings, including, for example, whether such options and settings had any effect on workers selecting or not selecting a flighted application version in the first place, and, for workers selecting a flighted application, whether such options and settings had any effect on the workers' results. Such correlations and other flighting results can then be returned to the task owner, such as is illustrated with the communication 139, thereby enabling the task owner to more meaningfully select option settings for their HITapp.

As one simple example, if the HITapp version 156 that was being flighted was a version in which a worker was offered a lower fee in exchange for performing HITs via the HITapp, and if the HITapp version 157 that was being flighted was a version in which the worker was offered a higher fee for performing HITs via the HITapp, the flighting component 122 could correlate such fees with whether or not those of the workers 140 that were flighted one of the HITapp versions 156 or 157 actually selected to perform HITs through such HITapp versions. Thus, in such an example, the results 139 could indicate, for example, that only one-third of workers being presented the HITapp version 156 with the lower fee selected such a HITapp version, while two thirds of workers being presented the HITapp version 157 selected that HITapp version. The results 139 could further indicate that, from among the workers performing HITs through either the HITapp version 156 or 157, those performing HITs through the HITapp version 157, offering the higher fee, were fifty percent more likely to generate results than those workers performing HITs through the HITapp version 156, offering the lower fee. According to one aspect, the results 139 can be provided with statistical significance information, such as “p-values” and other like indicators, which can be computed, such as by the flighting component 122, based upon the information collected from the workers 140, such as that described in detail above. Utilizing such results 139, the task owner can select option settings that, based on the results 139, are expected to provide higher quality HIT results generated by the workers 140, or otherwise optimize the HIT results generated by the workers 140 given the time, money and other resources invested by the task owner.

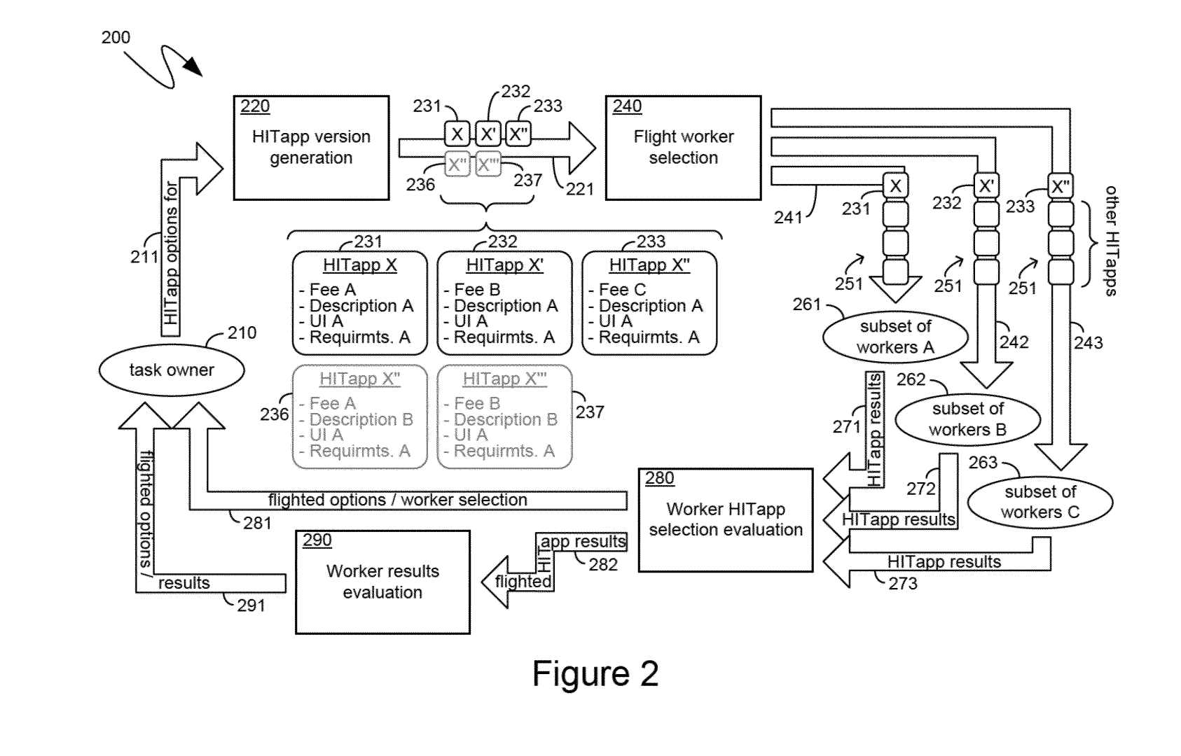

Turning to FIG. 2, the block diagram 200 shown therein illustrates an exemplary set of components and communications according to one aspect in which options and their corresponding settings can be flighted, such as in a crowdsourced environment. A task owner 210 can, as illustrated by the communication 211, identify options, and corresponding alternative settings thereof, that the task owner 210 seeks to have flighted. More specifically, the communication 211 can comprise options, and corresponding alternative settings thereof, that the task owner 210 desires to determine how such options, and corresponding alternative settings thereof, affect the HIT results generated by human workers. Such a communication 211 can provide such options, and the identified alternative settings thereof, to a HITapp version generation component 220. The HITapp version generation component 220 can generate versions of a single HITapp, with each version having a different option setting, or sets of option settings, corresponding to the options and identified alternative settings thereof that the task owner seeks to have flighted. As indicated previously, according to one aspect, the HITapp version generation component 220 can generate HITapp versions from a HITapp template that can be HIT-agnostic and can be utilized to generate HITapps for performing different types of HITs. As also indicated previously, according to another aspect, the HITapp version generation component 220 can generate HITapp versions from an initial HITapp that can be provided by the task owner 210, such as part of the communication 211. The HITapp version generation component 220 can vary the option settings within such an initial HITapp to generate the various HITapp versions that will be flighted. In yet another aspect, the HITapp version generation component 220 can be under the control of the task owner 210 and the task owner 210 indirectly provide, such as to a crowdsourcing service having a flighting component, the various HITapp versions that the task owner 210 desires to have flighted. In such an aspect, the task owner 210 can directly provide the HITapp versions, such as the exemplary HITapp versions 231, 232 and 233, or 231, 232, 236 and 237, shown as being provided via the communication 221.

For purposes of illustration, the exemplary system 200 of FIG. 2 shows exemplary HITapp versions 231, 232 and 233, with each having different settings for one option. More specifically, as an example for purposes of illustration, HITapp version 231 has associated with it certain description of the HITs presented through such a HITapp, a certain user interface for presenting the HITs, and certain requirements for the workers, or types of workers, that will be allowed to select the HITapp version 231. For purposes of the present, illustrative example, the HITapp version 232 and the HITapp version 233, both illustrated in FIG. 2, can comprise the same description, the same user interface and the same requirements, and can, likewise, share the same settings for other HITapp options or aspects. However, as illustrated in FIG. 2, for purposes of the present example, the HITapp version 231 can pay a certain fee to a worker for performing one or more HITs via the context provided by the HITapp, while the HITapp version 232 can pay a different fee and the HITapp version 233 can pay a still different fee. In other words, the HITapp versions 231, 232 and 233 can be utilized flight different fees for the performance of HITs to obtain empirical data regarding the effect that different fees will have on the quantity of workers selecting to perform such HITapp, as well as, optionally, the quantity and quality of HITapp results received for such fees.

As another example, illustrated in the alternative in the exemplary system 200 of FIG. 2, four different versions of a HITapp can be flighted to flight combinations of different settings of two or more options. For example, and as illustrated, HITapp version 231 and HITapp version 232 can be as described in detail above. However, in such an alternative example, HITapp version 236 can share the same settings as HITapp version 231, including the fee paid to a worker for the performance of one or more HITs through such a HITapp, but can differ in the description of the HIT that is provided to workers in order to enable workers to meaningfully decide whether or not to select the HITapp to perform the corresponding HITs in the first place. The HITapp version 237, then, can differ from the HITapp version 231 in both the fee paid to a worker for the performance of one or more HITs through such a HITapp and in the description of the HIT that is provided to workers. More specifically, the HITapp version 237 can be associated with a fee payment equal to that of HITapp version 232, which had a different amount from HITapp version 231, but shared the same description as HITapp version 231, and the HITapp version 237 can provide a description that is the same as that of HITapp version 236, which had a different description than that of HITapp version 231, but shared the same fee as offered by HITapp version 231. In such a manner, HITapp versions 231, 232, 236 and 237 can flight different settings for two or more options, such as, in the present example, different fee amounts and different descriptions, simultaneously.

Once such different HITapp versions are generated for flighting, they can be provided to a flight worker selection component 240, as illustrated by the communication 221. As indicated previously, according to one aspect, the communication 221 can be received directly from the task owner 210, if the task owner 210 generated the different HITapp versions for flighting themselves. The flight worker selection component 240 can then select subsets of the workers available to the crowdsourcing system to whom to flight the different versions of the HITapp provided via the communication 221. In so doing, the flight worker selection component 240 can interface with the task owner 210 to enable the task owner to, for example, identify a specific percentage of workers to whom such HITapp versions will be flighted.

As indicated previously, according to one aspect, only a subset of the workers communicating with the crowdsourcing system can be selected to receive flighted HITapps. In such an aspect, only ten percent, for example, of the workers communicating with the crowdsourcing system can receive flighted HITapps. Consequently, the flight worker selection component 240 can distribute the flighted HITapps to a subset of the workers communicating with the crowdsourcing system in accordance with such defined limitations. For example, if the task owner 210 had specified, or if the flight worker selection component 240 had determined, such as based on a quantity of HITapp versions being flighted, that only ten percent of the workers were to receive such flighted HITapps, then the flight worker selection component 240 can provide the HITapp version 231 to a subset of workers 261 that can comprise approximately three-and-one-third percent of the overall quantity of workers, as illustrated by the communication 241. Similarly, the flight worker selection component 240 can provide the HITapp version 232 to a subset of workers 262 that can, likewise, comprise approximately the same three-and-one-third percent of the overall quantity of workers, as illustrated by the communication 242, and the flight worker selection component 240 can also provide the HITapp version 233 to a subset of workers 263 that can also comprise approximately the same three-and-one-third percent of the overall quantity of workers, as illustrated by the communication 243.

The subset of workers 261, 262 and 263 need not comprise specifically pre-identified workers and can, instead, according to one aspect, be randomly selected in accordance with the size of such subsets as compared with the overall quantity of workers. For example, returning to the above example where each of the subset of workers 261, 262 and 263 can be approximately three-and-one-third percent of the overall quantity of workers, the selection of such subsets of workers, such as by the flight worker selection component 240, can be achieved by the flight worker selection component 240 randomly identifying approximately one out of every thirty-three workers that establish a communication connection with the crowdsourcing system as being a worker belonging to one of the subsets of workers 261, 262 or 263. As described in detail above, a single, individual worker can belong to multiple ones of the subsets of workers 261, 262 and 263 depending upon when, and how often, such an individual worker establishes a communication connection with the crowdsourcing system for purposes of selecting a HITapp through which to perform HITs.

In another aspect, the specific, individual workers, or the types of workers, populating the subsets of workers 261, 262 and 263 can be specifically selected, such as by the flight worker selection component 240. For example, the flight worker selection component 240 can specifically select workers that have previously indicated that they desire to participate in flights of HITapps to populate the subsets of workers 261, 262 and 263. As another example, the flight worker selection component 240 can specifically select workers based on their prior activities, generated HIT results, experience, geographic location, or other worker-specific factors to populate the subsets of workers 261, 262 and 263.

As individual workers belonging to one of the subsets of workers 261, 262 and 263 establish communications with the crowdsourcing system, the flight worker selection component 240, in combination with existing crowdsourcing system components, can provide one or more HITapps to such individual workers to enable the workers to select a HITapp through which they will perform HITs. Thus, for example, the communication 241 is shown, in FIG. 2, as providing those workers in the subset of workers 261 with the flighted HITapp version 231, as well as other HITapps 251. Similarly, the communication 242 is shown as providing those workers in the subset of workers 262 with the flighted HITapp version 232, as well as other HITapps 251 and the communication 243 is shown as providing those workers in the subset of workers 263 with the flighted HITapp version 233, as well as other HITapps 251. Although referred to by the same reference number, the individual HITapps comprising the other HITapps 251 need not be the same for each worker, and the utilization of the same reference number is merely meant to illustrate that such other HITapps 251 are all, equally, not one of the flighted HITapps 231, 232 or 233.

Responsive to the communications 241, 242 and 243, workers in the subset of workers 261, 262 and 263 can select one of the HITapps presented and can provide results to one or more HITs performed by such workers through the context generated by the selected HITapps. For purposes of completeness of description, the workers can also select none of the HITapps presented and can simply reestablish communications with the crowdsourcing system at a later point in time. Provision of the results, generated by the workers, for the one or more HITs performed by such workers through the HITapps selected by such workers, is illustrated by the communications 271, 272 and 273. As such, the communications 271, 272 and 273 comprise the results, generated by the subsets of workers 261, 262 and 263, respectively, as potentially influenced by the options, and the settings thereof, that are being flighted through the various versions of the relevant HITapp, namely the HITapp versions 231, 232 and 233, respectively.

In accordance with one aspect, a worker HITapp selection evaluation component 280 can obtain access to the results provided via the communications 271, 272 and 273 and can generate, therefrom, a correlation between the HITapp options that were flighted, and workers' selection of such flighted HITapp versions. For example, if only one-third of the workers in the subset of workers 261 selected the HITapp version 231, but two-thirds of the workers in the subset of workers 262 and 263 selected the HITapp versions 232 and 233, respectively, the worker HITapp selection evaluation component 280 could correlate a doubling of the quantity of workers selecting the HITapp with the increase in the fee from the fee associated with the HITapp version 231 to the fee associated with the HITapp version 232. Similarly, the worker HITapp selection evaluation component 280 could correlate a lack of change in the quantity of workers selecting the HITapp with the increase in the fee from the fee associated with the HITapp version 232 to the fee associated with the HITapp version 233. As indicated previously, such correlations can be expressed with confidence factors such as the well-known “p-values” in statistical analysis.

As can be seen, the worker HITapp selection evaluation component 280 can compare the quantity of workers to whom a particular HITapp version was presented with the quantity of workers actually selecting such a particular HITapp version. Additionally, the worker HITapp selection evaluation component 280 can compare the quantity of workers to whom a particular HITapp version was presented and the quantity of workers actually selecting such a particular HITapp version across the multiple different HITapp versions that were being flighted. Utilizing well-known statistical analysis, the worker HITapp selection evaluation component 280 can provide the correlations between the options and settings that differed across the various HITapp versions that were flighted, in other words the flighted options and settings, and the resulting behavior of the workers, especially in regards towards the performance of HIT by such workers. As will be recognized by those skilled in the art, a task owner, such as exemplary task owner 210, utilizes the flighting capabilities and the mechanisms described herein to identify worker reaction to various options, and settings thereof, in order to optimize the workers' performance of HITs of the task that is owned by the task owner. Thus, the correlations identified by the worker HITapp selection evaluation component 280, and provided to the task owner 210, such as via the exemplary communication 281, can be directed towards aiding the task owner in identifying options, and settings thereof, that will optimize the workers' performance of HITs of the task that is owned by the task owner.

While some of the workers in the subsets of workers 261, 262 and 263 may not select the HITapps being flighted, such as the HITapp versions 231, 232 and 233, those of the workers that do select such flighted HITapps can perform one or more HITs presented through such HITapps, and the results thereof can be received by the worker HITapp selection evaluation component 280. According to one aspect, such results can be communicated by the worker HITapp selection evaluation component 280 to the worker results evaluation component 290, as illustrated with exemplary communication 282. In other aspects, the worker results evaluation component 290 can be integrated with the worker HITapp selection evaluation component 280, either by themselves or with still other components of the crowdsourcing service.

The worker results evaluation component 290, like the worker HITapp selection evaluation component 280, can correlate flighted options, and the settings thereof, to worker behavior. More specifically, the worker results evaluation component 290 can correlate flighted options, and the settings thereof, to the HIT results generated by the workers performing HITs through the flighted HITapps that were selected by such workers. According to one aspect, such a correlation can simply correlate objective data associated with such HIT results. For example, the worker results evaluation component 290 can correlate flighted options, and the settings thereof, to the total quantity of HIT results provided, the efficiency with which such HIT results were generated, the quantity of HIT results generated by each individual worker, or other like objective data. As one simple example, the workers, from the subset of workers 261 that did select the flighted HITapp version 231, can have generated an average of ten HIT results per worker, the workers, from the subset of workers 262 that did select the flighted HITapp version 232, can have generated an average of twenty HIT results per worker, and the workers, from the subset of workers 263 that did select the flighted HITapp version 233, can have generated an average of thirty HIT results per worker. The worker results evaluation component 290 can correlate such HIT results, namely the HIT result quantities with the options, and settings thereof, being flighted, and can indicate, such as to the task owner 210, via the exemplary communication 291 that, given the above exemplary quantities, workers were fifty percent more productive in generating HIT results when paid the higher fee associated with the HITapp version 232 than when paid the lower fee associated with the HITapp version 231, but that workers were only thirty-three percent more productive in generating HIT results when paid the still higher fee associated with the HITapp version 233 than when paid the fee associated with the HITapp version 232.

According to one aspect, the worker results evaluation component 290 can, as an alternative, or in addition, incorporate information regarding the subjective quality of the HIT results provided by those of the workers, from among the subset of workers 261, 262 and 263 selecting the flighted HITapp versions 231, 232 and 233, respectively. As will be recognized by those skilled in the art, known mechanisms exist for evaluating the quality of HIT results, including comparing the HIT results generated by the workers, from among the subset of workers 261, 262 and 263 selecting the flighted HITapp versions 231, 232 and 233, respectively to known correct HIT results generated by trusted or expert workers, which HIT results are often colloquially referred to as “gold HITs”. Such mechanisms can already be part of a crowdsourcing system, and can, according to such an aspect, be incorporated by the worker results evaluation component 290. Alternatively, the worker results evaluation component 290 can simply, itself, include such subjective HIT result evaluation mechanisms. In addition to, or alternatively to, providing correlations between flighted options, and the settings thereof, and objective aspects of the HIT results, such as quantities, timeliness, and other like objective aspects, the worker results evaluation component 290 can also provide correlations between flighted options, and the settings thereof, in subjective aspects of the HIT results, such as correlations between the flighted options, and the settings thereof, and the quality of the HIT results generated by the workers utilizing the corresponding flighted HITapp versions.

As in the case of the worker HITapp selection evaluation component 280, therefore, the worker results evaluation component 290 can provide information that can enable a task owner, such as exemplary task owner 210, to utilize the flighting capabilities and the mechanisms described herein to identify worker reaction to various options, and settings thereof, in order to optimize the workers' performance of HITs of the task that is owned by the task owner. Thus, the correlations identified by the worker results evaluation component 290, and provided to the task owner 210, such as via the exemplary communication 291, can be directed towards aiding the task owner in identifying options, and settings thereof, that will optimize the workers' performance of HITs of the task that is owned by the task owner.

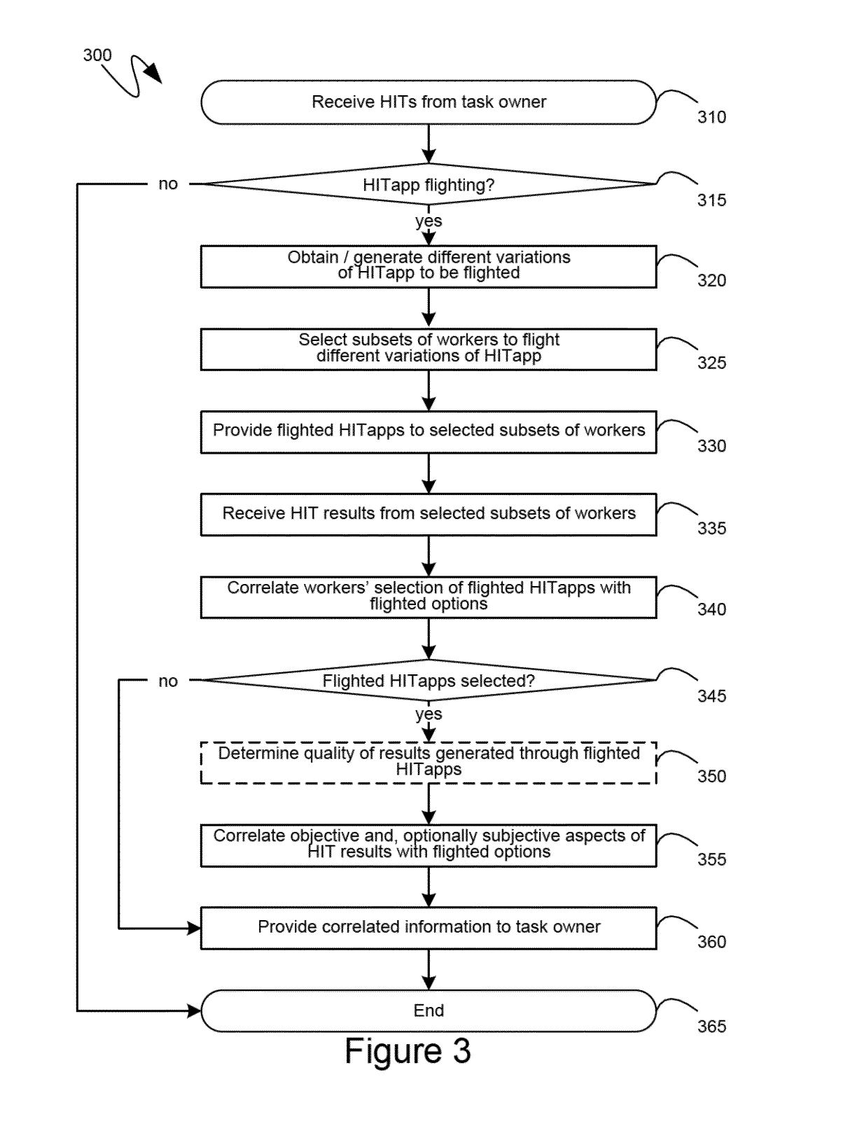

Turning to FIG. 3, the flow diagram 300 shown therein illustrates an exemplary series of steps that can be performed to enable flighting of options, and settings thereof, associated with HITapps and the HITs presented through the context generated by such flighted HITapps. Initially, as illustrated in FIG. 3, at step 310, the task owner can provide intelligence tasks, that, in aggregate, comprise a task that the task owner seeks to have completed by the workers of the crowdsourcing service. At step 315, a decision can be made, such as by the task owner, as to whether to flight one or more different versions of HITapps through which the HITs of step 310 will be presented to workers. The decision, at step 315, can be in response to a user interface or other like selection mechanism, that can be presented to the task owner. If the task owner does not desire to utilize HITapp flighting, then the relevant processing can end at step 365. Conversely, if, at step 315, the task owner elects to utilize HITapp flighting, then processing can proceed to step 320 where different options, and the settings thereof, can be flighted through the generation of multiple HITapp versions, with each version representing a particular collection of options and corresponding settings. As indicated previously, step 320 can entail guided generation of such multiple HITapp versions, or it can entail the receipt of such multiple HITapp versions, which can have already been generated by the task owner, or other mechanisms under the task owner's control.

Once the multiple HITapp versions to be flighted are obtained or generated, such as at step 320, processing can proceed to step 325, where subsets of workers are selected to receive the different HITapp versions being flighted. As described in detail above, such a selection of subsets of workers, at step 325, can comprise a determination of a percentage of workers to randomly receive a flighted HITapp version, or it can comprise identification of specific workers, or specific types of workers, to receive a flighted HITapp version. At step 330, the selection of workers, at step 325, can be utilized to provide the flighted HITapp versions to the selected subsets of workers. Subsequently, at step 335, HIT results can be received from those workers, and the results, indicative of the workers' selection of particular HITapps, can be correlated to the flighted options at step 340. More specifically, and as described in detail above, the HIT results received at step 335 can be indicative of whether any of the workers to whom one of the flighted HITapp versions were presented actually selected such a HITapp version and performed one or more HITs with it. Consequently, at step 340, correlations can be made based upon the quantity of workers to whom a particular flighted HITapp version was presented and the subsequent quantity of workers that actually selected such a flighted HITapp version.

Subsequently, at step 345, a determination can be made as to whether any of the HIT results, received at step 335, are from the flighted HITapp versions. If none of the HIT results received at step 335 are from the flighted HITapp versions, then processing can proceed with step 360, and the correlated information generated at step 340 can be provided to the task owner. Conversely, if some of the HIT results received at step 335 are from the flighted HITapp versions, then processing can proceed to step 350. At step 350, a quality of the HIT results from the flighted HITapp versions can be determined, or obtained from existing HIT result quality determination mechanisms. As described in detail above, such a step can be optional and is, therefore, illustrated via dashed lines in the exemplary flow diagram 300 of FIG. 3. At step 355, a correlation can be made between objective aspects of the HIT results from the flighted HITapp versions and the corresponding flighted options. For example, as detailed above, correlations can be made between quantities of HIT results generated, throughput, productivity, or efficiency of the workers generating the HIT results, and other like, objective aspects of the HIT results from the flighted HITapp versions. Additionally, optionally, subjective aspects of the HIT results from the flighted HITapp versions can also be correlated with the flighted options, such as, for example, the quality of the HIT results. At step 360, the correlated information generated at steps 340 and 355 can be provided to the task owner. As indicated previously, such information can include information indicative of certainty or likelihood, such as, for example, well-known statistical “p-values”. The relevant processing can then end at step 365. Although not specifically shown in exemplary flow diagram 300 of FIG. 3, the information provided to the task owner, such as at step 360, can enable the task owner to identify those options, and the settings thereof, that affect the quality of the HIT results generated by workers and can, thereby, facilitate the task owner's selection of option settings to optimize the quality of the HIT results generated by workers through a HITapp context defined by such option settings.

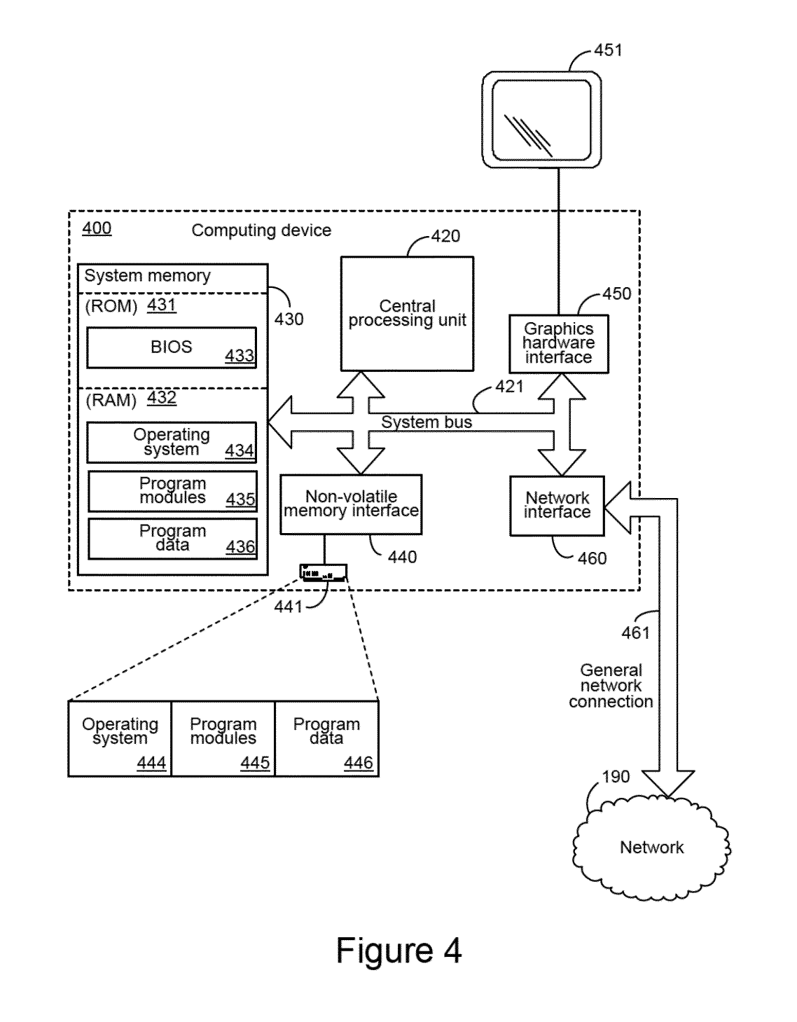

Turning to FIG. 4, an exemplary computing device 400 is illustrated which can perform some or all of the mechanisms and actions described above. The exemplary computing device 400 can include, but is not limited to, one or more central processing units (CPUs) 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. The computing device 400 can optionally include graphics hardware, including, but not limited to, a graphics hardware interface 450 and a display device 451, which can include display devices capable of receiving touch-based user input, such as a touch-sensitive, or multi-touch capable, display device. Depending on the specific physical implementation, one or more of the CPUs 420, the system memory 430 and other components of the computing device 400 can be physically co-located, such as on a single chip. In such a case, some or all of the system bus 421 can be nothing more than silicon pathways within a single chip structure and its illustration in FIG. 4 can be nothing more than notational convenience for the purpose of illustration.

The computing device 400 also typically includes computer readable media, which can include any available media that can be accessed by computing device 400 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. Computer storage media, however, does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computing device 400, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, other program modules 435, and program data 436.

The computing device 400 may also include other removable/non-removable, volatile/nonvolatile computer storage media. By way of example only, FIG. 4 illustrates a hard disk drive 441 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 441 is typically connected to the system bus 421 through a non-volatile memory interface such as interface 440.

The drives and their associated computer storage media discussed above and illustrated in FIG. 4, provide storage of computer readable instructions, data structures, program modules and other data for the computing device 400. In FIG. 4, for example, hard disk drive 441 is illustrated as storing operating system 444, other program modules 445, and program data 446. Note that these components can either be the same as or different from operating system 434, other program modules 435 and program data 436. Operating system 444, other program modules 445 and program data 446 are given different numbers hereto illustrate that, at a minimum, they are different copies.

The computing device 400 may operate in a networked environment using logical connections to one or more remote computers. The computing device 400 is illustrated as being connected to the general network connection 461 through a network interface or adapter 460, which is, in turn, connected to the system bus 421. In a networked environment, program modules depicted relative to the computing device 400, or portions or peripherals thereof, may be stored in the memory of one or more other computing devices that are communicatively coupled to the computing device 400 through the general network connection 461. It will be appreciated that the network connections shown are exemplary and other means of establishing a communications link between computing devices may be used.

Although described as a single physical device, the exemplary computing device 400 can be a virtual computing device, in which case the functionality of the above-described physical components, such as the CPU 420, the system memory 430, the network interface 460, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where the exemplary computing device 400 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executed within the construct of another virtual computing device. The term “computing device”, therefore, as utilized herein, means either a physical computing device or a virtualized computing environment, including a virtual computing device, within which computer-executable instructions can be executed in a manner consistent with their execution by a physical computing device. Similarly, terms referring to physical components of the computing device, as utilized herein, mean either those physical components or virtualizations thereof performing the same or equivalent functions.

As can be seen from the above descriptions, mechanisms for tuning crowdsourced human intelligence task options through flighting, have been presented. In view of the many possible variations of the subject matter described herein, we claim as our invention all such embodiments as may come within the scope of the following claims and equivalents thereto.

We claim:

1. A computing device for flighting different options affecting workers performing human intelligence tasks, the computing device comprising one or more processing units and computer-readable media comprising computer-executable instructions that, when executed by the processing units, cause the computing device to perform steps comprising:
providing, to a first subset of workers, a first version of an application generating a context through which workers perform the human intelligence tasks, the first version of the application having associated with it a first option setting affecting the first subset of workers' performance of the human intelligence tasks;
providing, to a second subset of workers, a second version of the application generating the context through which workers perform the human intelligence tasks, the second version of the application having associated with it a second option setting affecting the second subset of workers' performance of the human intelligence tasks;
receiving a first set of human intelligence task results from at least some of the first subset of workers;
receiving a second set of human intelligence task results from at least some of the second subset of workers; and
generating a correlation between a change between the first and second option settings and a difference between the first and second sets of human intelligence task results.

2. The computing device of claim 1, wherein the first and second option settings are different settings of a same option.

3. The computing device of claim 2, wherein the same option is a fee paid to workers for performing the human intelligence tasks.

4. The computing device of claim 2, wherein the same option is a description of the human intelligence tasks.

5. The computing device of claim 1, wherein the providing to the first subset of workers comprises randomly selecting workers based on a predetermined first fraction of an overall quantity workers that are to comprise the first subset of workers; and wherein the providing to the second subset of workers comprises randomly selecting workers based on a predetermined second fraction of the overall quantity workers that are to comprise the second subset of workers.

6. The computing device of claim 1, wherein the providing to the first and second subsets of workers comprises specifically selecting workers to comprise the first and second subsets of workers based on a predetermined worker criteria.

7. The computing device of claim 1, wherein the difference between the first and second sets of human intelligence task results comprises a difference between a first quantity of workers, from among the first subset of workers, that selected the first version of the application and a second quantity of workers, from among the second subset of workers, that selected the second version of the application.

8. The computing device of claim 1, wherein the difference between the first and second sets of human intelligence task results comprises a difference between an objective aspect of the first set of human intelligence task results and the same objective aspect of the second set of human intelligence task results.

9. The computing device of claim 1, wherein the difference between the first and second sets of human intelligence task results comprises a difference between an subjective aspect of the first set of human intelligence task results and the same subjective aspect of the second set of human intelligence task results.

10. The computing device of claim 9, wherein the same subjective aspect is a human intelligence task result quality.

11. The computing device of claim 1, comprising further computer-executable instructions that, when executed by the processing units, cause the computing device to perform further steps comprising: receiving different settings of an option, the different settings of the option comprising both the first and the second option settings; and generating the first and second versions of the application based on the received different settings of the option.

12. A method for flighting different options affecting workers performing human intelligence tasks, the method comprising the steps of:
providing, to a first subset of workers, a first version of an application generating a context through which workers perform the human intelligence tasks, the first version of the application having associated with it a first option setting affecting the first subset of workers' performance of the human intelligence tasks;
providing, to a second subset of workers, a second version of the application generating the context through which workers perform the human intelligence tasks, the second version of the application having associated with it a second option setting affecting the second subset of workers' performance of the human intelligence tasks;
receiving a first set of human intelligence task results from at least some of the first subset of workers;
receiving a second set of human intelligence task results from at least some of the second subset of workers; and
generating a correlation between a change between the first and second option settings and a difference between the first and second sets of human intelligence task results.

13. The method of claim 12, wherein the first and second option settings are different settings of a same option.

14. The method of claim 12, wherein the providing to the first subset of workers comprises randomly selecting workers based on a predetermined first fraction of an overall quantity workers that are to comprise the first subset of workers; and wherein the providing to the second subset of workers comprises randomly selecting workers based on a predetermined second fraction of the overall quantity workers that are to comprise the second subset of workers.

15. The method of claim 12, wherein the providing to the first and second subsets of workers comprises specifically selecting workers to comprise the first and second subsets of workers based on a predetermined worker criteria.

16. The method of claim 12, wherein the difference between the first and second sets of human intelligence task results comprises a difference between a first quantity of workers, from among the first subset of workers, that selected the first version of the application and a second quantity of workers, from among the second subset of workers, that selected the second version of the application.

17. The method of claim 12, wherein the difference between the first and second sets of human intelligence task results comprises a difference between an objective aspect of the first set of human intelligence task results and the same objective aspect of the second set of human intelligence task results.

18. The method of claim 12, wherein the difference between the first and second sets of human intelligence task results comprises a difference between an subjective aspect of the first set of human intelligence task results and the same subjective aspect of the second set of human intelligence task results.

19. The method of claim 12, comprising further computer-executable instructions that, when executed by the processing units, cause the computing device to perform further steps comprising: receiving different settings of an option, the different settings of the option comprising both the first and the second option settings; and generating the first and second versions of the application based on the received different settings of the option.

20. One or more computer-readable media comprising computer-executable instructions for flighting different options affecting workers performing human intelligence tasks, the computer-executable instructions directed to steps comprising:
providing, to a first subset of workers, a first version of an application generating a context through which workers perform the human intelligence tasks, the first version of the application having associated with it a first option setting affecting the first subset of workers' performance of the human intelligence tasks;
providing, to a second subset of workers, a second version of the application generating the context through which workers perform the human intelligence tasks, the second version of the application having associated with it a second option setting affecting the second subset of workers' performance of the human intelligence tasks;
receiving a first set of human intelligence task results from at least some of the first subset of workers;
receiving a second set of human intelligence task results from at least some of the second subset of workers; and
generating a correlation between a change between the first and second option settings and a difference between the first and second sets of human intelligence task results.
